(19) United States
(12) Patent Application Publication
(10) Pub. No.: US 2005/0005739 A1
(43) Pub. Date: Jan. 13, 2005

(54) Fluorescent life hammer

(76) Inventor: Alfred Langerak, Mijnsheerenland (NL)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/468,311

(22) PCT Filed: Feb. 14, 2002
(86) PCT No.: PCT/NL02/00096

(30) Foreign Application Priority Data
Feb. 14, 2001 (NL) 1017362

(51) Int. Cl. B25D 1/00

(52) U.S. Cl. 81/26; 206/577

(57) ABSTRACT

The invention relates to safety device (1) for breaking glass, provided with a housing (2) and a head (4), wherein the head is provided with a relatively hard end (14), wherein at least a part of the housing is provided with a fluorescent outer surface (30). The invention also relates to a method for manufacturing a safety device, wherein at least two housing parts (2) are injection-molded, provided at least a part of the outer surface with an in-mold label (20) which is of fluorescent design, which housing parts are assembled for forming the housing of the safety device, wherein between at least a part of the parts of the housing a head is included extending at least partly outside the housing and being provided with at least one relatively hard end.

The invention relates to a safety device for the breaking of glass. Such a safety device is known as a safety hammer and is marketed under the name life hammer.

U.S. Pat. No. 5,952,916 (Yamabe) discloses a safety device, provided with a hammer head and a handle. The handle houses a light bulb, several LEDs and a battery. A fluorescent material may be applied to an inner surface of the handle. As long as the device is mounted on a holder the light and LEDs are switched off. At removal of the device from said holder, the light and LEDs are automatically activated, thus enabling the device to serve as an emergency signal instrument.

In emergencies, it has been found that escaping from, for instance, vehicles or buildings can be made impossible or considerably more difficult by closed windows or windows which cannot or insufficiently easily be opened. To prevent this problem, the known safety device has been put on the market. Herewith, in a simple manner, the obstructing glass can be broken, whereupon escape is still possible. Such a safety device seems very effective in itself. However, it has been found that the position of this safety device is not always sufficiently clear. In particular in dark surroundings, the use of such safety devices is rendered difficult in that its position is not always clear.

The invention contemplates a safety device of the type described in the preamble, wherein tho drawbacks mentioned of the known safety device have been obviated, while maintaining its advantages. To that end, a safety device according to the invention is characterized by the features of claim 1.

With a safety device according to the present invention, it has been found that, precisely by using a fluorescent surface or at least a part thereof, location of these safety devices is considerably simplified, without, to that end, for instance, electric provisions being required. The fact is that during at least a part of the time, in the normal waiting position, there where it has been suspended clearly visible in case of emergencies, this safety device is exposed to (day) light. Usually, this time will be sufficient to obtain the desired fluorescent action, in particular when a relatively bright color is used, such as orange, red or yellow which are generally experienced as being alarming. Furthermore, also in normal (day) light circumstances such coloration offers an enhanced visibility. Through the use of a fluorescent surface, no external light source is required for considerably increasing the visibility, which would be necessary, for instance, when using a reflecting surface. In particular in situations when lighting has completely ceased, for instance in case of fire or in a vehicle fallen into the water, with failing electric provisions or the like, the safety of persons present is thereby enhanced such that lives will thus be saved.

With a safety device according to the present invention, it is preferred to provide the or each fluorescent surface by the use of in-mold labeling techniques, whereby a label with a fluorescent print is placed in a mold cavity of, for instance, an injection mold, whereupon at least a part of the safety device, for instance a housing part, is injection-molded against it, so that an integral connection is obtained. Thus, the fluorescent action ceasing to exist is prevented in a simple manner. The fact is that the fluorescent surfaces can no longer be separated from the safety device. It is noted, for that matter, that a comparable effect can be achieved by providing a suspension device for such a safety device with an at least partly fluorescent outer surface, in addition to or instead of the safety device.

The invention further relates to a method for manufacturing a safety device for breaking glass, characterized by the features of claim 9.

Such a method offers the advantage that in a particularly simple and economical manner, a safety device according to the invention can be formed which maintains its functionality for a longer period of time.

In the further subclaims, further advantageous embodiments of a safety device according to the invention are given.

In elucidation of the invention, exemplary embodiments of a safety device and a method according to the invention will be explained in more detail with reference to the drawing.

In the drawing:

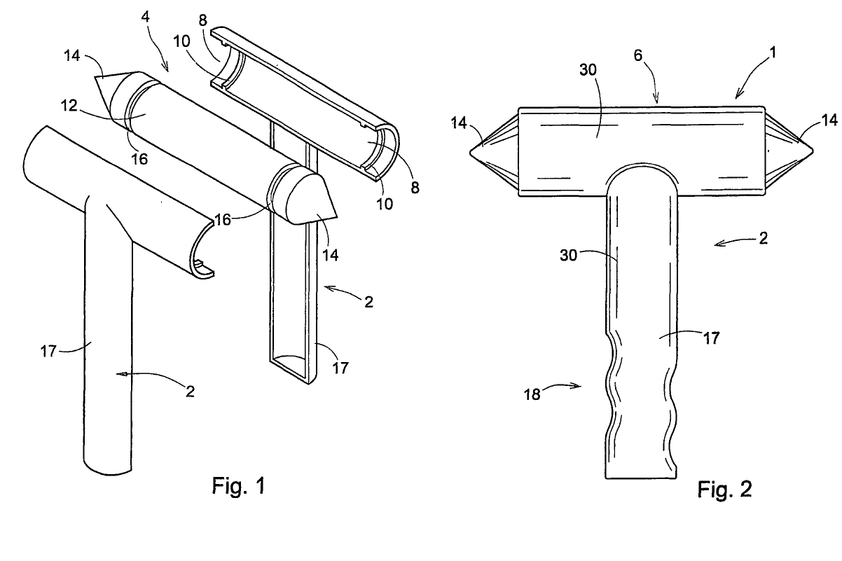

FIG. 1 shows, in disassembled condition, a safety device according to the invention, in the shape of a hammer;

FIG. 2 shows a safety device according to FIG. 1, in assembled condition; and

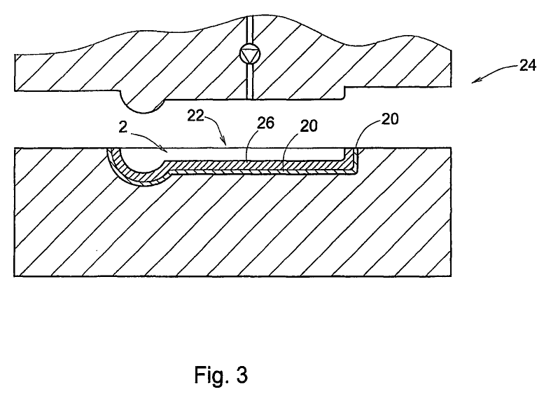

FIG. 3 shows, in cross-sectional side view, a mold part with mold cavity, an in-mold label and a product part formed against it.

In this description, identical or corresponding parts have identical or corresponding reference numerals.

FIG. 1 shows, in disassembled condition, a safety device 1, according to the invention, comprising two housing parts 2 and a head 4. In this embodiment, the housing parts 2 are identical to each other and have a front view which is a substantially somewhat T-shaped. The housing parts 2 are dish parts, injection-molded and thin-walled. The horizontal beam 6 of each T-shaped housing part 2 is largely semi-cylinder-shaped with open ends 8, which open ends are bounded by an edge 10 reaching inwards. When the two T-shaped housing parts 2 are brought against each other as shown in FIG. 2, where they can, for instance, be glued, sealed or welded together or be connected to each other in a different manner, the two beams 6 together form a cylinder-shape with open ends 8. The head 4 is formed by a solid metal cylinder 12 having conical ends 14. Preferably, the head 4 is hardened. Adjacent each conical end 14, a circular groove 16 has been provided, in which the edge 10 can engage when the head 4 is received between the beams 6. Thus, the head 4 is locked in between the housing parts 2. In the assembled condition shown in FIG. 2, the upright legs 17 of the housing parts 2 form a handle 18.

In the exemplary embodiment shown, each housing part 2 is provided at the outside with a fluorescent print 30, for instance in fluorescent orange, yellow or red. Here, fluorescent orange or yellow appears to lead to the best results, but any other desired fluorescent color is possible. This fluorescent outer surface can be provided by, for instance, printing the outer surface of each of the housing parts 2 after formation with a fluorescent ink, by spraying with fluorescent paint or by providing it with fluorescent printed labels such as stickers or the like. The latter technique is particularly suitable for substantially single-curved or flat parts, for instance rings on the handle 18 or around the beam 6.

In a preferred embodiment, a safety device 1 according to the invention is formed with a method wherein a device is used such as, for instance, shown partly in cross section in FIG. 3. In this method, a label 20 with fluorescent properties is placed in a mold cavity 22, whereupon the mold 24 is closed and, in a manner known per se, plastic is injected in the mold cavity 22 against the label 20. Then, partial fusion occurs between the label 20 and the plastic 26, at least such that a fixed connection therebetween is obtained. Upon ejection of the thus formed housing part 2, the label 20, and, hence a print 30 optionally applied thereon, forms an integral part of the respective housing part 2. The fluorescent properties of the respective label 20 can be obtained by printing it with fluorescent ink or paint, prior to placement in the mold cavity 22, but can, for instance, also be obtained by specific selection of fluorescent plastic for forming the respective label. If such a label is manufactured as a laminate, one of the layers can be of fluorescent design, optionally covered by a permanent transparent cover layer. It is preferred that, prior to placement in the mold cavity 22, the label 20 is already partly brought into the desired shape the label should eventually have on the housing part 2, for instance with the aid of vacuum forming techniques, by a deep or thin drawing technique or such deforming techniques known per se. Thus, relatively thin foil can be used while damages occurring to this foil during injection of the plastic in the mold can be prevented. Naturally, the desirability of such predeformation also depends on the degree of deformation of the label from a flat position to the final shape. For instance with single curved surfaces or relatively flat surfaces, such predeformation is less necessary. Also, the housing parts can be completely or partly manufactured from fluorescent plastic.

The invention is not limited in any way to the exemplary embodiments given in the description and in the drawings. Many variations thereon are possible within the framework of the invention as outlined by the claims.

For instance, a safety device according to the invention can be manufactured in a different manner, for instance by blow molding, rotational molding, assembly from several parts and the like. Also, the head can be designed differently and be secured in the housing in a different manner. Also, a housing of a safety device according to the invention could be designed to be wholly or partly transparent, with fluorescent means disposed therein. Also, such a safety device can be combined with other signaling means, for instance a breaking light included therein, which breaks at undesirably large accelerations or decelerations, so that the visibility of the safety device is thereby increased, also in case no or insufficient fluorescent action is present. Such a break light can also be sufficient in itself.

The invention is not limited in any way to the exemplary embodiments presented in the description. Many variations thereon are possible within the framework of the invention as outlined by the claims, while all aspects mentioned can be used both separately and in combination with each other.

1. A safety device for breaking glass, provided with a housing (2) built up from at least two housing parts and a head (4), the head (4) being provided with a relatively hard end (14), characterized in that at least a part of the housing (2) is provided with a fluorescent outer surface.

2. A safety device according to claim 1, wherein the housing (2) is manufactured from plastic which is of fluorescent design.

3. A safety device according to claim 2, wherein the plastic is fluorescent.

4. A safety device according to claim 1, wherein at least a part of the housing (2) is provided with a fluorescent print (30).

5. A safety device according to claim 4, wherein at least a part of the fluorescent print (30) has been provided with the aid of in-mold-labeling technique.

6. A safety device according to claim 1, wherein the entire housing (2) on the outside is of fluorescent design.

7. A safety device according to claim 1, wherein the housing comprises two parts (2), wherein each of the parts (2) is provided at the outside with a fluorescent surface.

8. A safety device according to claim 1, wherein at least a part of the fluorescent surface has been obtained by injection or printing with the aid of paint or ink after formation of the respective parts (2) of the housing.

9. A method for manufacturing a safety device (1), wherein at least two housing parts (2) are injection-molded, provided with at least a part of an outside surface with an in-mold label (20) which is of fluorescent design, which housing parts (2) are assembled for forming the housing of the safety device (1), wherein between at least a part of the parts of the housing (2) a head (4) is included extending at least partly outside the housing and being provided with at least one relatively hard end (14).

10. A safety device according to claim 7, wherein the parts are mirror symmetrical.
